(19) United States
(12) Patent Application Publication
(10) Pub. No.: US 2013/0280078 A1
(43) Pub. Date: Oct. 24, 2013

(54) Wind Turbine Blade Pitch Redundant Safety Arrangement

(71) Applicant: John BOYLAND, Christiansburg, VA (US)

(72) Inventor: John BOYLAND, Christiansburg, VA (US)

(73) Assignee: Kollmorgen Corporation, Radford, VA (US)

(21) Appl. No.: 13/453,368

(22) Filed: Apr. 23, 2012

(51) Int. Cl. B64C 11/06

(52) U.S. Cl. 416/205

(57) ABSTRACT

A wind turbine includes a blade position adjustment system providing for continued wind turbine blade repositioning operation even after the occurrence of certain faults. The system includes a plurality of electrically operable motors, each of which is interconnected with one of the wind turbine blades to reposition that wind turbine blade and modify the blade pitch. Each motor includes two or more sets of electrically isolated windings, and a power supply is separately interconnected with each of the electrically isolated winding sets to provide for continued repositioning of each blade upon occurrence of a fault, such as voltage or current deterioration, in one of the winding sets.

### BACKGROUND OF THE INVENTION

1. Field of the Invention

This invention finds application in wind farm power generation arrangements, and is considered particularly beneficial when used in conjunction with off-shore wind farm arrangements or arrangements disposed in other locations with limited access.

2. Description of Related Art

Wind turbine rotor blade pitch adjustment is commonly used to mitigate effects of asymmetric loads on turbine components. U.S. Pat. Nos. 4,193,005 and 4,420,692 to Kos et al., 4,201,514 to Huetter, 4,348,155 to Barnes et al., 4,352,629 to Cheney, Jr., 4,435,647 to Harner et al., 6,465,901 to Croes, 7,004,724 and 7,160,083 to Pierce, et al., 7,342,323 to Avagliano et al., and 7,530,785 to Deering et al., for example, relate to this sort of technology.

The Pierce et al. ('724) patent concerns a method and an apparatus for load control in which the pitch of each wind turbine blade is individually controlled to reduce turbine component fatigue and loading. In the Pierce et al. ('724) arrangement, a blade pitch controller is coupled to one or more blade rotation drives. By varying the pitch of the blades using such controllers, the magnitude and/or duration of loads placed on the Pierce et al. ('724) wind turbine can be reduced, and the overall performance of the turbine can be improved as a result. The entire disclosure provided by the Pierce et al. ('724) patent is expressly incorporated by reference into the present disclosure as non-essential subject matter.

### SUMMARY OF THE INVENTION

A wind turbine blade position adjustment system according to the invention provides for continued wind turbine blade repositioning operation even after the occurrence of certain faults. The system includes a plurality of electrically operable motors, each of which is interconnected with one of the wind turbine blades to reposition that wind turbine blade and modify the blade pitch. Each motor includes two or more sets of electrically isolated windings. A power supply is separately interconnected with each of the electrically isolated winding sets to provide for continued repositioning of each of the wind turbine blades upon occurrence of a fault, such as voltage or current deterioration, in one of the winding sets. A fault indication arrangement may be interconnected with the motors to ascertain performance deterioration in any of the electrically isolated winding sets.

In one arrangement, the power supply is separately interconnected with each of the electrically isolated winding sets by separate conductive lines. A control unit may be used to regulate output from the power supply based, for example, on information received about wind or other forces exerted on the turbine blades.

### BRIEF DESCRIPTION OF THE DRAWINGS

FIG. 1a is a schematic illustration of part of an overall wind turbine blade pitch adjustment system according to one embodiment of the present invention.

FIG. 1b is a schematic illustration of the remainder of the system shown in FIG. 1.

FIG. 2 is a schematic illustration of part of a more practical embodiment of the invention in which each motor of the system has its own control and power supply.

FIG. 3 is a schematic illustration of part of another embodiment of the invention in which each independently excitable winding set in every motor of the system has its own control and power supply.

### DETAILED DESCRIPTION OF THE INVENTION

The present invention concerns utilizing certain types of electric motors to produce load control by individually adjusting the pitch of each of a plurality of wind turbine blades to reduce turbine component fatigue and loading in an improved manner. Electric motors and technology generally relating to electric motors and other power transmission arrangements find applications in a wide variety of fields. U.S. Pat. No. 4,547,713 to Langley, for example, concerns a motor usable as a scanner drive for a radar system. Further examples include U.S. Pat. No. 4,562,399 to Fisher, which relates to a brushless DC tachometer operable over a wide speed range, U.S. Pat. No. 6,084,330 to Fisher et al., which concerns a rotor construction applied to electronically commutated high speed motors, U.S. Pat. No. 6,433,536 to Yundt et al., which discloses a position indicator using multiple sensors to provide redundancy, and U.S. Pat. No. 6,705,581 to Trago et al., concerning a mount assembly for an electric motor usable to drive an endless belt at a predetermined tension.

In certain applications, motors having independently excitable, redundant winding sets are considered preferable to ensure system operation in the event of failure of a winding or its associated drive circuit. U.S. Pat. No. 4,434,389 to Langley, for example, discloses a DC electric servomotor with a stator including multiple non-overlapping sets of redundant windings potentially usable to assist in the positioning of aircraft control surfaces. U.S. Pat. No. 5,929,549 to Trago et al. is another example, and concerns a brushless DC motor possibly finding application in safety, medical, and life support systems. The entire disclosure provided by the Langley ('389) patent and the entire disclosure provided by the Trago et al. ('549) patent are expressly incorporated by reference into the present disclosure as non-essential subject matter.

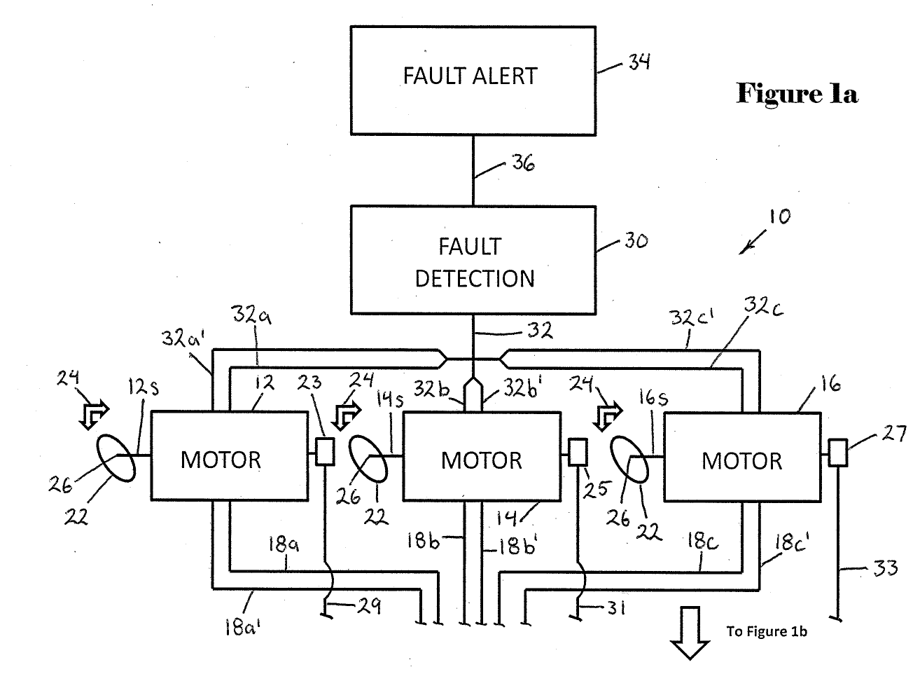

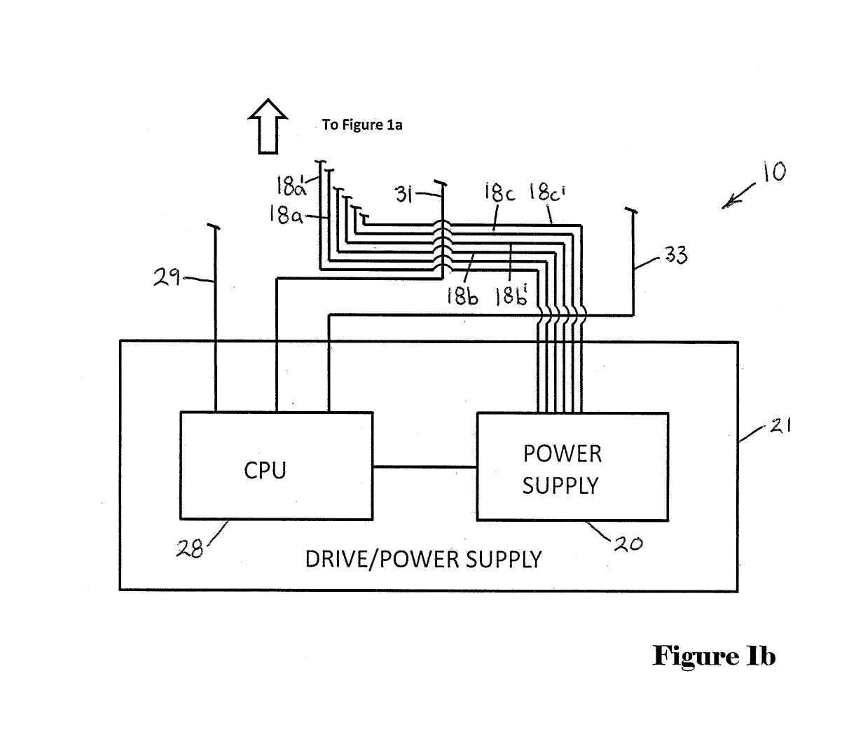

The wind turbine blade pitch adjustment system 10 shown in FIGS. 1a and 1b includes a plurality of electric motors 12, 14, and 16. In the illustrated system, the electric motors 12, 14, and 16 are interconnected by way of respective conductive lines 18a, 18a′, 18b, 18b′, and 18c, 18c′ to outputs of a power supply 20.

Each of the motors 12, 14, and 16 has a respective output shaft 12s, 14s, and 16s, with each of these output shafts being connected, directly or by way of appropriate gearing, to a respective wind turbine blade 22, so that rotation of that shaft produces corresponding rotation of the associated wind turbine blade for pitch adjustment. It will be understood that rotation of any of the blades 22 about a blade axis 26 in the directions indicated by arrows 24 effects a change in the pitch of that blade 22. Adjustment of blade positions could be based on output received from a central processing unit (CPU) 28 or other control unit by the power supply 20. The power supply 20 and the CPU 28 collectively form at least part of an overall drive/power supply 21.

Output provided by the CPU 28 could factor into account signals from control circuitry, usable in applicable pitch control algorithms, relating to wind forces exerted on the blades 22, and signals from feedback devices 23, 25, and 27, forming parts of overall servo systems respectively, including the motors 12, 14, and 16 and the drive electronics in the CPU 28, could be taken into consideration. Each feedback device 23, 25, or 27, for example, could be connected directly to a motor shaft 12s, 14s, or 16s, and could be operable to continuously report the actual motor shaft position to the CPU 28 or other such drive microprocessor by way of lines 29, 31, and 33. Using such feedback devices enables the drive to make small corrections in order to minimize any error between the commanded shaft positions and the actual shaft positions. In a wind turbine blade pitch adjustment system, a commanded position would typically be the optimal turbine blade pitch angle. Continually monitoring and correcting the error closes the servo loop.

According to the present invention, each of the motors 12, 14, and 16 used in the system 10 represented in FIG. 1a is a motor having independently excitable, redundant winding sets (not shown). The Langley ('389) and the Trago et al. ('549) patents identified previously disclose examples of such motors. The motor 12 shown in FIG. 1, for example, could include two such independently excitable winding sets, with one of these two sets excitable by way of the line 18a and the other set excitable by way of the line 18a′. Similarly, the motor 14 could include two independently excitable winding sets, with one of these two sets excitable by way of the line 18b and the other set excitable by way of the line 18b′, while the motor 16 could also include two independently excitable winding sets, with one of these two sets excitable by way of the line 18c and the other set excitable by way of the line 18c′. If desired, of course, instead of the two winding sets mentioned, three or more sets of independently excitable windings with respective conductive lines could be provided to the stators of the motors 12, 14, and 16.

Also shown a part of the system illustrated in FIG. 1 is one possible fault indication arrangement. As illustrated, a fault detection element or circuit 30 is respectively interconnected with the motors 12, 14, and 16 by way of branches 32a, 32a′, 32b, 32b′, and 32c, 32c′ of a conductive line 32. Wireless communication instead of the conductive line 32 and its branches could be used if desired. To illustrate one possible manner of operation, it will be presumed, by way of example and for the purposes of this discussion only, that two sets of independently excitable windings are utilized in each of the motors 12, 14, and 16. If a short circuit occurs in one of the two sets of windings utilized in the motor 12, the existence of voltage or current deterioration in that winding set can be communicated, by way of the relevant branch 32a or 32a′ and the conductive line 32, to the fault detection element or circuit 30, which, in turn, can output a signal to a fault alarm 34 or other indicator by way of a communication line 36, or wirelessly if appropriate, to provide notification. Voltage or current deterioration in either of the winding sets utilized in the motor 14 or the motor 16 can be communicated to the element or circuit 30, by way of the relevant branch 32b, 32b′, 32c, or 32c′ and the line 32, to actuate the fault alarm 34 or other indicator, via the line 36 or wirelessly, in similar fashion.

By way of a system such as that described, redundancy on a “per blade” basis is provided for electric motors utilized in wind turbine blade pitch adjustment applications. Redundant motion control and actuation circuitry are provided for each turbine blade 22 of the system, so that, if one motor winding of any of the motors 12, 14, and 16 fails, the other circuit of the relevant motor can provide emergency, near half-performance motion. This feature allows a more fault-tolerant implementation of reliability-sensitive wind turbine power generation market applications. When a fault of the sort mentioned occurs, it is possible to have the wind turbine continue to generate power, albeit at reduced capacity, while the fault detection circuitry alerts personnel of the need for maintenance. Maintenance could be scheduled, and, in the meantime, the turbine would be able to continue to generate power. This is considered particularly beneficial for off-shore wind farm power generation arrangements, as access difficulties may limit response time, and the associated down-time could be very costly.

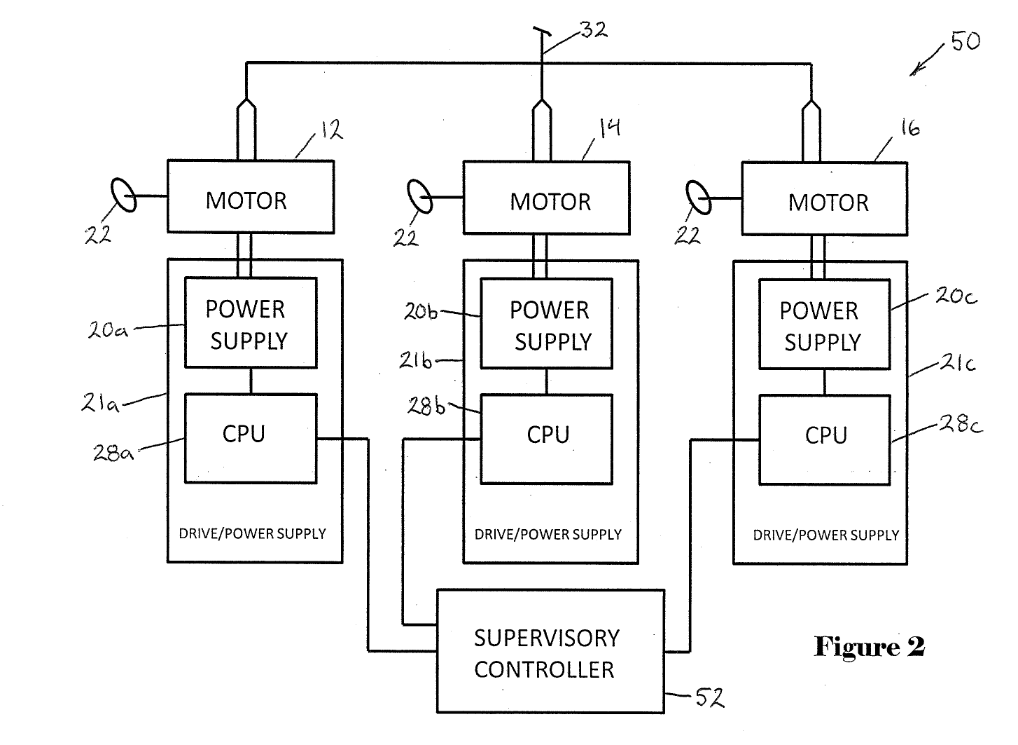

For simplicity, the illustration provided by FIGS. 1a and 1b, and the description associated therewith, identify only one CPU 28 and one power supply 20 as feeding the three motors 12, 14, and 16. For redundancy and to be practical, however, each of the motors 12, 14, and 16 would have its own control and power supply. FIG. 2 is a schematic illustration of part of one type of a more practical wind turbine blade pitch adjustment system 50, in which each motor of the system has its own drive/power supply 21a, 21b, and 21c, including respective control units (CPUs) 28a, 28b, and 28c and power supplies 20a, 20b, and 20c. The fault detection and alarm and feedback arrangements represented in FIGS. 1a and 1b are not illustrated in FIG. 2 for simplicity. The CPUs 28a, 28b, and 28c shown in FIG. 2 are interconnected with a supervisory controller 52, enabling manual override operations and other sorts of input.

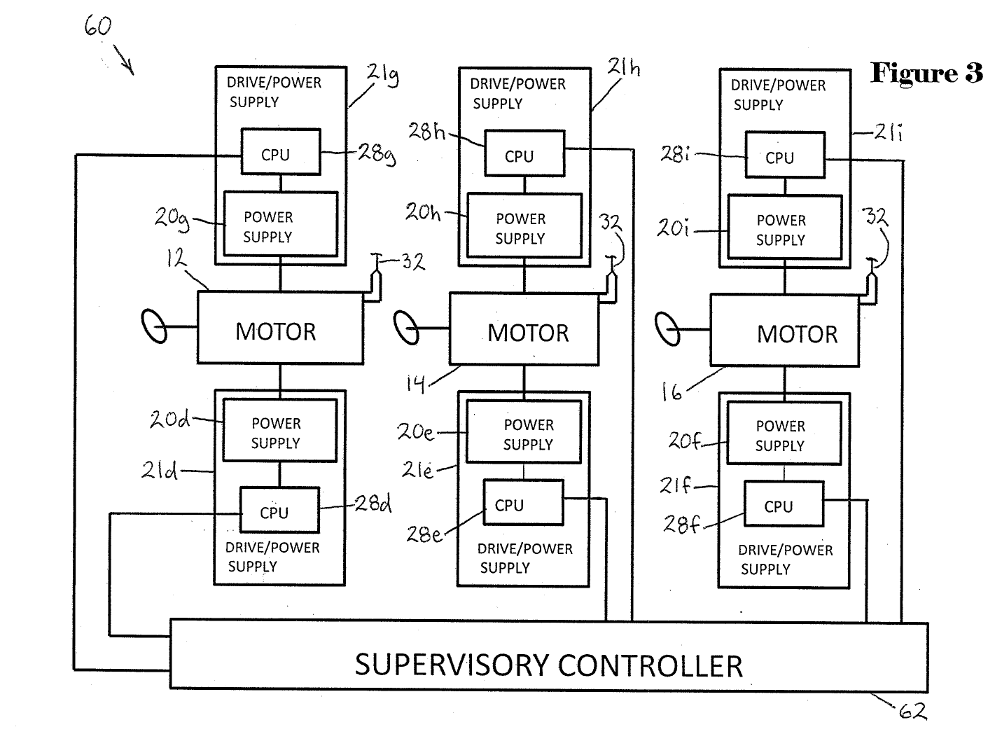

FIG. 3 is a schematic illustration of part of another embodiment of the invention in which each independently excitable winding set in every motor of a wind turbine blade pitch adjustment system 60 has its own control and power supply. Again, it will be presumed, by way of example and for the purposes of this discussion only, that two sets of independently excitable windings are utilized in each of the motors 12, 14, and 16. It will also be noted that, while a conductive line 32 leading to a fault detection and alarm arrangement is represented in FIG. 3, for simplicity, neither the fault detection and alarm arrangement itself, nor a feedback arrangement such as that represented in FIGS. 1a and 1b, is illustrated in FIG. 3. As each of the three motors 12, 14, and 16 shown in FIG. 3 presumably includes two independently excitable winding sets, six drive/power supplies 21d, 21e, 21f, 21g, 21h, and 21i, including respective control units (CPUs) 28d, 28e, 28f, 28g, 28h, and 28i and power supplies 20d, 20e, 20f, 20g, 20h, and 20i, are utilized. The CPUs 28d-28i shown in FIG. 3, once again, are interconnected with a supervisory controller 62, enabling manual override operations and other sorts of input.

It will be understood that, in the arrangement illustrated in FIG. 2, each motor has more than one winding, but a single control and power supply. In this case, if a motor winding faults with an open circuit, any healthy redundant circuits remain active. In the arrangement illustrated in FIG. 3, however, while each motor, again, has more than one winding, each winding has its own control and power supply. Any fault within any part of the circuit would disable that circuit, and any healthy redundant circuits remain active.

This invention allows both independent blade position redundancy and more robust redundancy through the use of two or more independent windings and controls that share a common rotor and mechanics. Redundant winding sets can provide full performance when used together, or partial performance when fewer than all of the winding sets are operational. By way of the invention, desirable redundancy features are applied in a new way to improve pitch control on wind turbines.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A wind turbine blade position adjustment system providing for continued wind turbine blade repositioning operation after occurrence of a fault, comprising:
a plurality of electrically operable motors, each of said motors being interconnected with one of the wind turbine blades to reposition said one of the wind turbine blades and including multiple sets of electrically isolated winding sets, and
a power supply separately interconnected with each of the electrically isolated winding sets to provide for continued repositioning of each of the wind turbine blades upon occurrence of a fault in one of the electrically isolated winding sets.

2. The wind turbine blade position adjustment system of claim 1, wherein the wind turbine blade position adjustment system modifies turbine blade pitch.

3. The wind turbine blade position adjustment system of claim 1, further comprising a fault indication arrangement interconnected with the motors to ascertain performance deterioration in any of the electrically isolated winding sets.

4. The wind turbine blade position adjustment system of claim 1, wherein each electrically isolated winding set has at least two windings.

5. The wind turbine blade position adjustment system of claim 1, wherein said power supply is separately interconnected with each of the electrically isolated winding sets by separate conductive lines.

6. The wind turbine blade position adjustment system of claim 1, further comprising a control unit for regulating output from said power supply.

7. The wind turbine blade position adjustment system of claim 2, further comprising a fault indication arrangement interconnected with the motors to ascertain performance deterioration in any of the electrically isolated winding sets.

8. The wind turbine blade position adjustment system of claim 2, wherein said power supply is separately interconnected with each of the electrically isolated winding sets by separate conductive lines.

9. The wind turbine blade position adjustment system of claim 3, wherein said power supply is separately interconnected with each of the electrically isolated winding sets by separate conductive lines.

10. The wind turbine blade position adjustment system of claim 2, further comprising a control unit for regulating output from said power supply.

11. The wind turbine blade position adjustment system of claim 3, further comprising a control unit for regulating output from said power supply.

12. The wind turbine blade position adjustment system of claim 5, further comprising a control unit for regulating output from said power supply.

13. A wind turbine in which wind turbine blade repositioning operations are permitted to continue after occurrence of a fault, comprising:
a plurality of electrically operable motors, each of said motors being interconnected with one of the wind turbine blades to reposition said one of the wind turbine blades and including multiple sets of electrically isolated winding sets, and
a power supply separately interconnected with each of the electrically isolated winding sets to provide for continued repositioning of each of the wind turbine blades upon occurrence of a fault in one of the electrically isolated winding sets.

14. The wind turbine of claim 13, wherein the motors modify turbine blade pitch.

15. The wind turbine of claim 13, further comprising a fault indication arrangement interconnected with the motors to ascertain performance deterioration in any of the electrically isolated winding sets.

16. The wind turbine of claim 13, wherein each electrically isolated winding set has at least two windings.

17. The wind turbine of claim 13, wherein said power supply is separately interconnected with each of the electrically isolated winding sets by separate conductive lines.

18. The wind turbine of claim 13, further comprising a control unit for regulating output from said power supply.

19. The wind turbine of claim 14, further comprising a fault indication arrangement interconnected with the motors to ascertain performance deterioration in any of the electrically isolated winding sets.

20. The wind turbine of claim 15, wherein said power supply is separately interconnected with each of the electrically isolated winding sets by separate conductive lines.
